(19) United States
(12) Patent Application Publication
(10) Pub. No.: US 2010/0328025 A1
(43) Pub. Date: Dec. 30, 2010

(54) AMUSEMENT PARK MANAGEMENT SYSTEM

(75) Inventor: Pankaj RAZDAN, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/551,464

(22) Filed: Aug. 31, 2009

(30) Foreign Application Priority Data
Jun. 29, 2009 (KR) 10-2009-0058358

(51) Int. Cl. G05B 19/00; G06Q 10/00; G06Q 50/00

(52) U.S. Cl. 340/5.7; 705/5

(57) ABSTRACT

The amusement park management system comprises at least one mobile communication device containing identification information and transmitting reservation information including the number of reserved seats in a corresponding amusement facility out of a plurality of amusement facilities in an amusement park; a plurality of wireless network devices provided in the way ins/outs of the amusement park and the amusement facilities to form a mutual wireless local area network, and making an access to the mobile communication device to store the identification information and the reservation information including the number of reserved seats in the corresponding amusement facility; and a plurality of entry systems provided in gates of the amusement facilities to communicate with each of the plurality of wireless network devices, wherein each of the plurality of entry systems compares the identification information of the mobile communication device stored in the wireless network devices of the corresponding amusement facility with the identification information of the mobile communication device, compares the number of users using the corresponding amusement facility with the number of reserved seats in the corresponding amusement facility and controls the users' entrance and exit of sites according to the comparison results.

### CROSS-REFERENCE TO RELATED APPLICATIONS

This application claims the priority of Korean Patent Application No. 2009-0058358 filed on Jun. 29, 2009, in the Korean Intellectual Property Office, the disclosure of which is incorporated herein by reference.

### BACKGROUND OF THE INVENTION

1. Field of the Invention

The present invention relates to an amusement park management system, and more particularly, to an amusement park management system capable of reducing users' waiting time in use of amusement facilities by using a wireless based system to check utilization of the amusement facilities and make advance reservations for the amusement facility ride.

2. Description of the Related Art

In general, when a user wants to visit amusement parks such as Disneyland and enjoy a variety of amusement facilities, the user has to wait in a queue around adjacent sites of the amusement facilities since there are always many other people who visit the amusement park.

As a result, many amusement facility users often spend their leisure time not in enjoying the amusement facilities and playing around with their friends but in waiting in a queue to enjoy the amusement facilities, which causes big annoyance or inconvenience to amusement park users.

### SUMMARY OF THE INVENTION

The present invention is designed to solve the problems of the prior art, and therefore it is an object of the present invention to provide an amusement park management system capable of reducing users' waiting time in use of amusement facilities by using a wireless based system to check utilization of the amusement facilities and make advance reservations for the amusement facility ride.

According to an aspect of the present invention, there is provided an amusement park management system including at least one mobile communication device containing identification information and transmitting reservation information including the number of reserved seats in a corresponding amusement facility out of a plurality of amusement facilities in an amusement park; a plurality of wireless network devices provided in the way ins/outs of the amusement park and the amusement facilities to form a mutual wireless local area network, and making an access to the mobile communication device to store the identification information of the mobile communication device and the reservation information; and

a plurality of entry systems provided in gates of the amusement facilities to communicate with each of the plurality of wireless network devices, wherein each of the plurality of entry systems compares the identification information of the mobile communication device stored in the wireless network devices of the corresponding amusement facility with the identification information of the mobile communication device, compares the number of users using the corresponding amusement facility with the number of reserved seats in the corresponding amusement facility and controls the users' entrance and exit of sites according to the comparison results.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a general system in an amusement park according to one exemplary embodiment of the present invention.

FIG. 2 is a diagram illustrating the communications between FFDs and mobile communication devices as shown in FIG. 1.

FIG. 3 is a diagram illustrating an entry system of an amusement facility as shown in FIG. 1.

FIG. 4 is a diagram illustrating a reservation procedure ((a) to (d)) on a display block of the mobile communication device as shown in FIG. 2.

FIG. 5 is a diagram illustrating final reservation lists.

FIG. 6 is a diagram illustrating a message informing that a boarding time for the reserved amusement facility as shown in FIG. 5 is drawing near.

FIG. 7 is a diagram illustrating a protocol stack configuration of a data region that is processed by a ZigBee system according to one exemplary embodiment of the present invention.

FIG. 8 is a schematic block diagram illustrating components of a ZigBee communication module according to one exemplary embodiment of the present invention.

FIG. 9A is a diagram illustrating a predefined list that is transmitted from a FFD when the mobile communication device makes access to the FFD.

FIG. 9B is a diagram illustrating a FFD information table containing information lists of respective FFDs on network.

FIG. 9C is a diagram illustrating a FFD information table containing the time and the number of usable seats at a given time.

FIG. 9D shows one example of the FFD information table as shown in FIG. 9C.

FIGS. 10A and 10B are diagrams illustrating procedures of an amusement park reservation management protocol.

FIG. 11 is a flowchart illustrating procedures of making visitor's reservations.

### DETAILED DESCRIPTION OF THE PREFERRED EMBODIMENT

Exemplary embodiments of the present invention will now be described in detail with reference to the accompanying drawings.

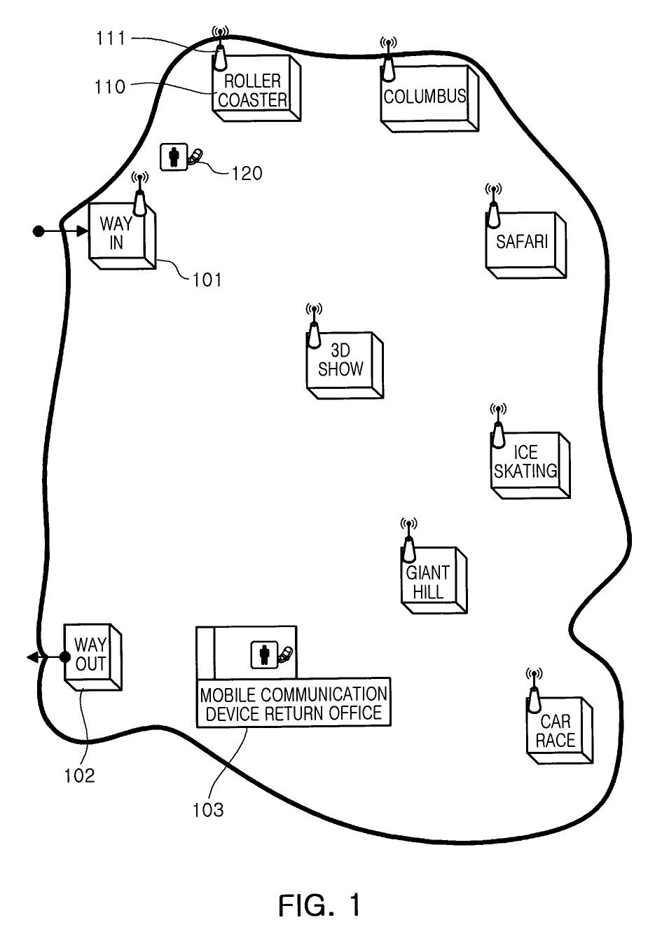

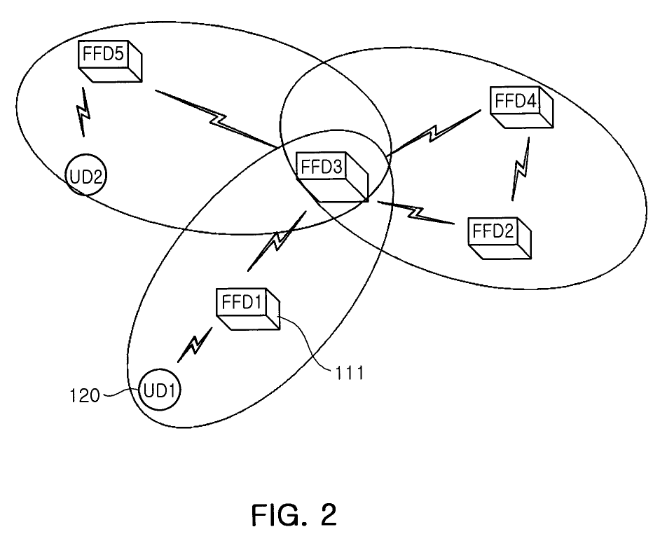

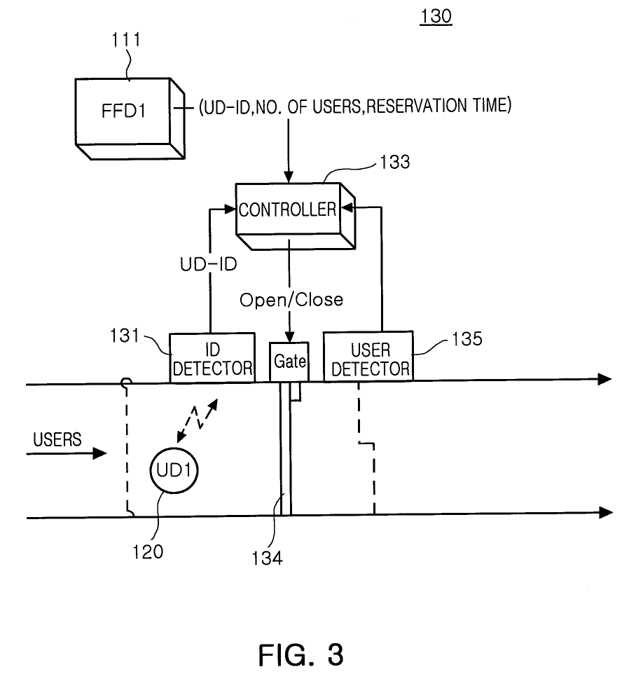

FIG. 1 is a diagram illustrating a general system in an amusement park according to one exemplary embodiment of the present invention, FIG. 2 is a diagram illustrating the communications between FFDs and mobile communication devices as shown in FIG. 1, and FIG. 3 is a diagram illustrating an entry system of an amusement facility as shown in FIG. 1.

As shown in FIGS. 1 to 3, the general system in the amusement park according to one exemplary embodiment of the present invention is characterized in that the general system at least one mobile communication device 120 containing identification information and transmitting reservation information including the number of reserved seats in a corresponding amusement facility 110 out of a plurality of amusement facilities 110 in an amusement park; a plurality of wireless network devices (i.e., a plurality of full functional devices 111) provided in all the way ins/outs of the amusement park and the amusement facilities 110 to form a mutual wireless local area network, and making an access to the mobile communication device 120 to store the identification information of the mobile communication device 120 and the reservation information including the number of reserved seats in the corresponding amusement facility 110; and a plurality of entry systems 130 provided in all gates of the amusement facilities to communicate with each of the plurality of FFDs 111,

wherein each of the plurality of entry systems 130 compares the identification information of the mobile communication device 120 stored in the FFDs 111 of the corresponding amusement facility 110 with the identification information of the mobile communication device 120, compares the number of users detected at facility 110 with the number of reserved seats in the corresponding amusement facility 110 and controls the users' entrance and exit of sites according to the comparison results.

Here, a separate counter may be further provided in the way in 101 of the amusement park. Such a counter may be used to charge admission from visitors, for example, users, of the amusement facilities 110 and to provide an admission ticket and the mobile communication device 120 for the reservation of the amusement facilities 110, etc. Of course, because a FFD 111 is installed in a place where the counter is positioned, the FFD 111 may be shared with other FFDs 111 by using specific information such as identification information, for example, identification number stored in internal memory, of the mobile communication device 120 provided to people who enter the amusement park, which renders it possible for the people to communicate with each other.

Also, a mobile communication device return office 103 is separately provided in the way out 102 of the amusement park. Therefore, the mobile communication devices 120 may be easily recovered from users who walk out of the amusement park after the riding of the amusement facilities 110.

In addition to the separate memory for storing information such as the identification information and/or the information (i.e. a resident registration number) on users of the mobile communication device 120 as described above, the mobile communication device 120 basically includes a display block for displaying data information on a screen thereof, such as a mobile phone or a personal digital assistant (PDA); a driving unit for communicating with the FFDs 111; and an alarm device for generating warning sounds according to the information of the FFDs 111.

Therefore, a user may make reservation and cancellation of the amusement facilities 110 according to the data information displayed on the display block of the mobile communication device 120, and may recognize that a boarding time for the reserved amusement facility 110 is drawing nearby means of warning sounds generated from the alarm device.

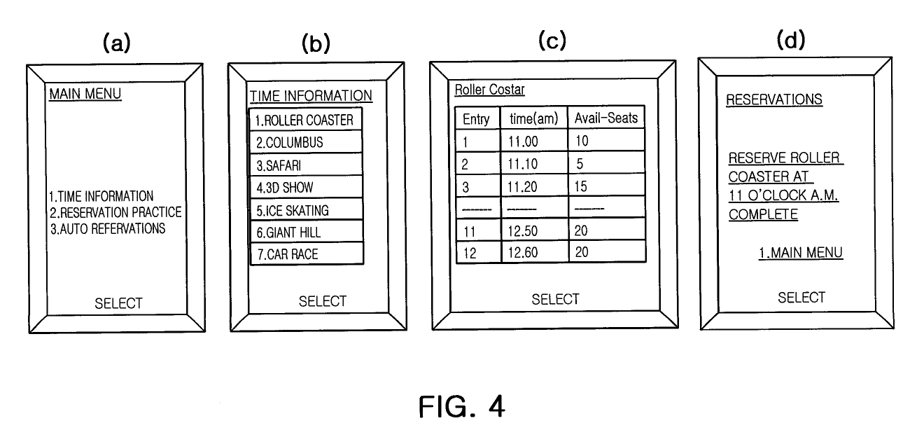

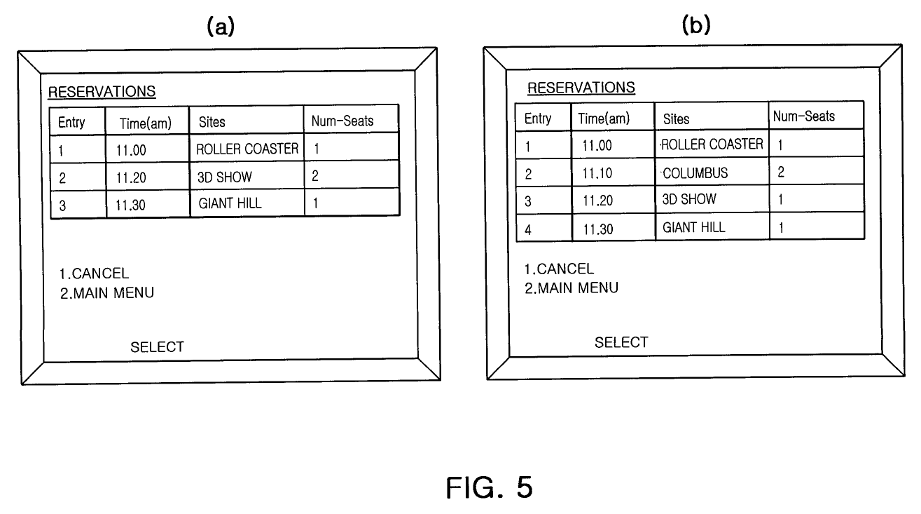

In this regard, FIG. 4 is a diagram illustrating a reservation procedure ((a) to (d)) on a display block of the mobile communication device, and FIG. 5 is a diagram illustrating final reservation lists ((a) and (b)).

Referring to FIG. 4(a) to (d) along with FIGS. 1 to 3, all items are dividedly displayed on a screen of the mobile communication device 120 in order to facilitate reservations for a variety of the amusement facilities 110 made on the display block of the mobile communication device 120, and a user selects a certain item for the amusement facilities 110 that the user wants to use, and check the number of available seats and make reservations.

In this manner, a user may make a total reservation list for the amusement facilities 110 that the user wants to use, as shown in FIGS. 5(a) and (b).

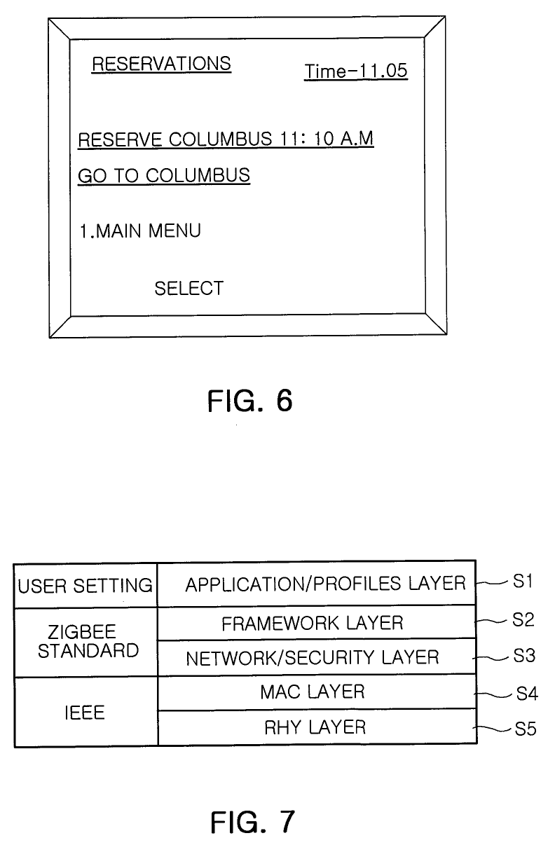

FIG. 6 is a diagram illustrating a message informing that a boarding time for the reserved amusement facility as shown in FIGS. 5(a) and (b) is drawing near.

When a boarding time for the reserved amusement facility 110 draws near after the user made the reservation list, the user hear an alarm message from the display block of the mobile communication device 120, as shown in FIG. 6. Also, the user can also hear warning sounds from the alarm device.

In accordance with the present invention, ZigBee (IEEE 802.15.4 having characteristics of ZigBee-Pro) or wireless LAN (WLAN; EEE 802.11a/b/g/n+802.11s) are preferably used to facilitate the communication between the mobile communication device 120 and the FFDs 111. In this case, the ZigBee is preferred to the WLAN in that the ZigBee is more effective in terms of manufacturing costs than the WLAN, and also has more various (or sufficient) functions than the WLAN.

Such ZigBee, which is referred to as one of wireless local area network standards, is one of wireless personal area networks (hereinafter, referred to as ‘WPAN’) technologies used to realize near field communication (NFC) and ubiquitous computing in places such as homes and offices, or local areas.

Of course, the WPAN technologies include wireless LAN, Bluetooth and the like, as well as the ZigBee. However, the ZigBee is more effective than the wireless LAN or the Bluetooth. This is why that a life span of batteries last for a longer time since the power consumption of the ZigBee is lower than the wireless LAN or the Bluetooth, a hardware configuration of the ZigBee is simpler since its protocol is simpler than the wireless LAN or the Bluetooth, and the ZigBee has excellent price competitiveness as well.

Therefore, ZigBee communication equipment can transmit data at a rate of 250 Kbps within the maximum range of 200 m, and may use a mesh network architecture to connect approximately 65,000 devices to one wireless network. Also, ZigBee using a free wireless frequency band may transmit/receive data free of charge by using a wireless local area communication network.

The ZigBee communication network may be formed in the form of star, mesh, tree, and combinations thereof. Each circle as shown in FIG. 2 means that a communication network is formed between wireless network devices, that is, between the FFDs 111, or between the FFDs 111 and the mobile communication devices 120.

The communication equipment forming the ZigBee communication network may be divided into a coordinator and a device according to its role. The coordinator is communication equipment that acts as a master for the ZigBee communications, and the device is communication equipment that acts as a slave. The coordinator and the device store mutual users' data (or identification number) in advance and enable the mutual communications.

Therefore, the mobile communication device 120 may act as either a coordinator or a device according to its role. In this case, according to the present invention, the mobile communication device 120 acts as a device, and the FFD 111 mutually communicating with the mobile communication device 120 acts as a coordinator.

For example, a configuration of a mobile phone according to the present invention that may enable the ZigBee communication may include a ZigBee communication module transmitting/receiving data according to ZigBee communication systems; a key pad outputting commands or data generated by handling of a user's button; and a processor controlling an operation of the ZigBee communication module in response to the commands, as disclosed in Korean Registered Patent No. 884550.

Meanwhile, a variety of the amusement facilities 110 such as roller coaster, ice skating and car racing are provided in corresponding sites in the amusement park, and a plurality of wireless network devices, that is, FFDs 111 are provided in each of the amusement facilities 110 in order to manage reservation information including the number of reserved seats in the corresponding amusement facilities 110. Here, the plurality of wireless network devices form a wireless local area network in order to search one of the mobile communication devices 120 that is positioned in the nearest distance from the amusement facilities 110 to communicate with each other, and also to allow the communication between the mobile communication devices 120.

More specifically, the FFDs 111 typically functions to form a network between FFDs 111 or between the FFDs 111 and the mobile communication devices 120, manage an information table (FFD_Info_Table) stored in each FFD 111, process a message about the reservation management protocol, order an automated reservation for the mobile communication device 120 to the FFDs 111 tied up according to the request of the automated reservation for the mobile communication device 120, and detect the mobile communication device 120 using specific information, that is, ID numbers, of the mobile communication device 120. In this regard, general contexts will be described in more detail in connection with the reservation management protocol.

In order to perform these functions, the FFDs 111 may communicate in the same ZigBee or WLAN manner as in the mobile communication device 120 as described above, but the ZigBee communication system is preferred to the WLAN communication system. In this ZigBee communication system,

communication equipment acting as a master can act as a coordinator to store users' mutual data (or specific information) in advance and mutually communicate with the mobile communication device 120 acting as a slave.

Further, in accordance with the present invention, it is possible to interactively communicate between the FFDs 111 as the coordinators, which act as the master, using the ZigBee communication system.

Therefore, each FFD 111 stores information on the mobile communication device 120 and also stores specific information, that is, ID numbers of other FFDs 111 as well, thus to communicate with the mobile communication device 120.

In this case, the ZigBee communication module 220 of the FFD 111 performing the ZigBee communication is substantially identical to the ZigBee communication module of the mobile phone previously described above.

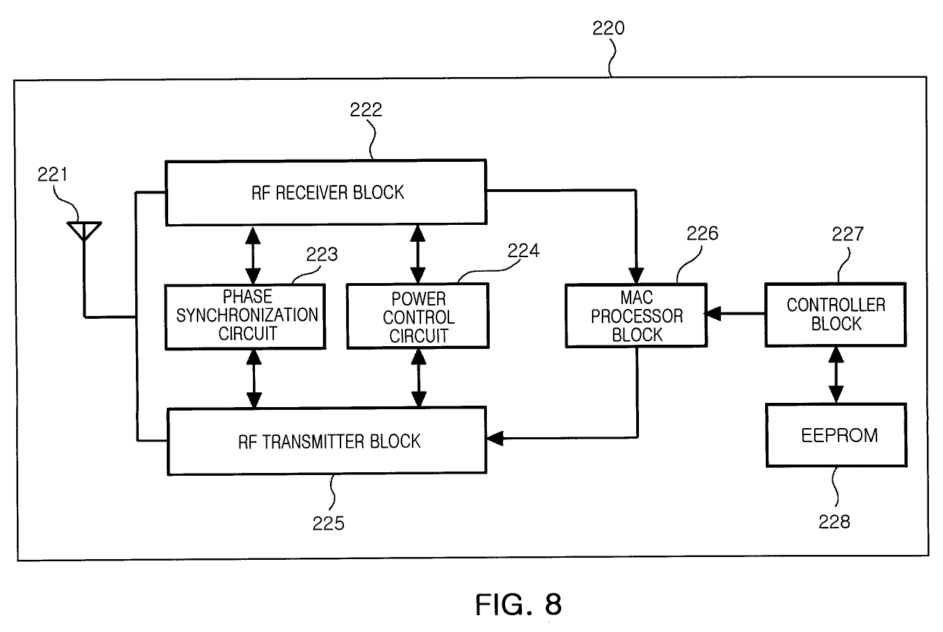

FIG. 7 is a diagram illustrating a protocol stack configuration of a data region that is processed by a ZigBee system according to one exemplary embodiment of the present invention, and FIG. 8 is a schematic block diagram illustrating components of a ZigBee communication module according to one exemplary embodiment of the present invention.

Referring to FIGS. 7 and 8 along with FIGS. 1 to 3, for the FFD 111 or the mobile communication device 120 according to one exemplary embodiment of the present invention, a protocol stack of the ZigBee communication module 220 may be mainly divided into a physical (PHY) layer (S5), a media access controller (MAC) layer (S4), a network/security layer (S3), an application framework layer (S2), and an application/profiles layer (S1). In this case, the PHY layer (S5) and the MAC layer (S4) correspond to regions as stipulated in the IEEE 802.15.4 standard, the network/security layer (S3) and the frame layer (S2) correspond to regions as stipulated in the ZigBee alliance standard, and the application/profiles layer (S1) corresponds to a user-defined region.

Based on this fact, the ZigBee communication module 220 according to one exemplary embodiment of the present invention includes an antenna 221, a RF receiver block 222, a RF transmitter block 225, a phase-locked loop (PLL) 223, a MAC processor block 226, a controller block 227 and an electrically erasable programmable read-only memory (EEPROM) 228. In this case, the ZigBee communication module 220 may further include a power control circuit 224.

The RF receiver block 222, the RF transmitter block 225, the phase-locked loop 223 and the power control circuit 224 are components that process operations corresponding to the PHY layer (S5) of the ZigBee protocol stack. In this case, they function to determine a RF communication architecture and a network topology.

The RF receiver block 222 and the RF transmitter block 225 includes an amplifier, a filter and the like and function to process a frequency signal of a corresponding band, and the phase-locked loop 223 functions to provide a reference frequency signal so that the RF receiver block 222 and the RF transmitter block 225 can synthesize an intermediate frequency signal, and the power control circuit 224 functions to determine the intensity of the received signal and adjust an amount of transmitted power.

The IEEE 802.15.4 standard defines two kinds (2.4 GHz, 866/915 MHz) of PHY layers (S5), and allots 16 channels in a 2.4 GHz band range, 10 channels in a band range of 902 MHz to 928 MHz, and one channel in a band range of 868 MHz to 870 MHz.

The RF receiver block 222 and the RF transmitter block 225 uses a direct sequence spread spectrum (DSSS). Here, an offset-quadrature phase-shift keying (O-QPSK) modulation system with a 32 PN code length is used in a band range of 2.4 GHz, and a binary phase-shift keying (BPSK) modulation system with 15 PN code length is used in a band range of 1 GHz or less.

When an analog signal is processed, the RF receiver block 222 and the RF transmitter block 225 process a digital signal of a base band region. Here, the RF receiver block 222 performs processes such as synchronization, dispreading, demodulating, and digital-filtering of the digital signal, and the RF transmitter block 225 performs processes such as spreading and pulse shaping of the digital signal.

In this case, when the BPSK modulation system is used, base band processing channels constituted by the RF receiver block 222 and the RF transmitter block 225 may be unified into one channel.

When the digital processing of the PHY layer (S5) is completed, the MAC processor block 226 analyzes a frame structure of the transmitted data signal to approve frames, senses errors (error detection: using CRC or Checksum) to determine whether a data signal is re-transmitted, and processes packet routing. Here, the packet represents a frame unit including information on address, data and the like.

That is to say, the MAC processor block 226 is a constitutional block for processing the connection of initial hardware networks, and provides an additional frame structure associated with beacon for time synchronization and guaranteed time slot (GTS; used for collision/delay prevention) and processes the connection of channels in a carrier sense multiple access with collision avoidance (CSMACA) manner.

The controller block 227 forms a network topology by performing functions of the other MAC layers (S4), namely, MAC layers (S4) called software MAC processor block (Software-MAC) corresponding to the hardware MAC processor block (Hardware-MAC), functions of the network/security layer (S3) and functions of the frame layer (S2), and transmit application data by performing functions of the application/profiles layer (S1).

Network topology configuration information such as equipment information, channel information of nodes is recorded in the EEPROM 228, and data arithmetically operated at the MAC processor block 226 and the controller block 227 are temporally stored in the EEPROM 228, and information on the analysis of the protocol is also stored in the EEPROM 228.

Meanwhile, referring to FIGS. 1 to 3, each of the amusement facilities 110 is provided with an entry system 130 that may allow the entrance according to the specific information of the mobile communication device 120 and the users' reservation information for the amusement facilities 110.

Such an entry system 130 includes an ID detector 131 detecting specific information, that is, ID of the mobile communication device 120; a user detector 135 detecting user information, for example, the number of users reserved for the amusement facilities; and a controller 133 comparing the identification number of the mobile communication device 120, which provides the data information, namely the reservation information provided from the wireless network device 111, and the reservation information of the corresponding amusement facilities 110 with detection information of the ID detector 131 and the user detector 135, and controlling the entrances 134 of the amusement facilities 110 according to the comparison results.

Here, the ID detector 131 functions to detect ID stored in the mobile communication device 120 when a user carrying the mobile communication device 120 approaches the ID detector 131 to use a certain amusement facility 110. And, the ID detector 131 provides the detected information to the controller 133.

Also, the controller 133 determines whether the information (or signals) detected by the ID detector 131 is matched with the specific information of the mobile communication device 120 that has been reserved for the corresponding FFD 111 that manages the reservation of the amusement facilities 110, and then opens the entrance 134 of the amusement facility 110 when the information (or signals) detected by the ID detector 131 is matched with the specific information of the mobile communication device 120. For example, the controller 133 may control the opening and closing of the entrance 134 by pushing and pulling a cylinder installed in the entrance 134.

Also, the user detector 135 detects the number of users, namely, the number of reserved seats for users who is passing through the entrance 134. That is to say, when the users passed through entrance 134 is 3, the user detector 135 detects 3 users and provides a detection signal for the 3 users to the controller 133.

For example, a 3-bit detection signal of “001” for one user detected by the user detector 135 may be obtained by subtracting 3-bit data information of “011”, which represents the number of reserved seats provided to the controller 133, three times.

As described above, the controller 133 determines whether the number of seats reserved in the corresponding FFD 111 is matched with the detection information, and closes the entrance 134 when the\number of reserved seats is matched with the detection information.

In this manner, the entry system 130 repeatedly performs the opening/closing of the entrance 134 in response to each of the mobile communication devices 120.

Hereinafter, the communication protocol is described in brief with reference to the information list (FFD-Info_List) transmitted between the mobile communication device 120 and the FFD 111, or between the FFDs 111.

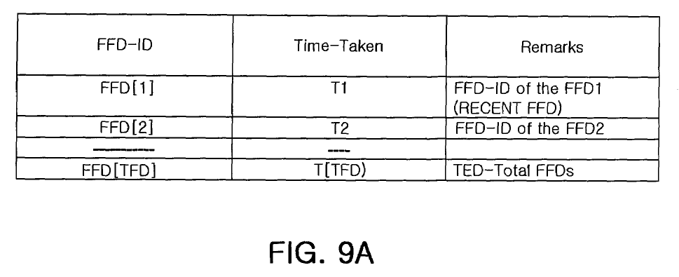

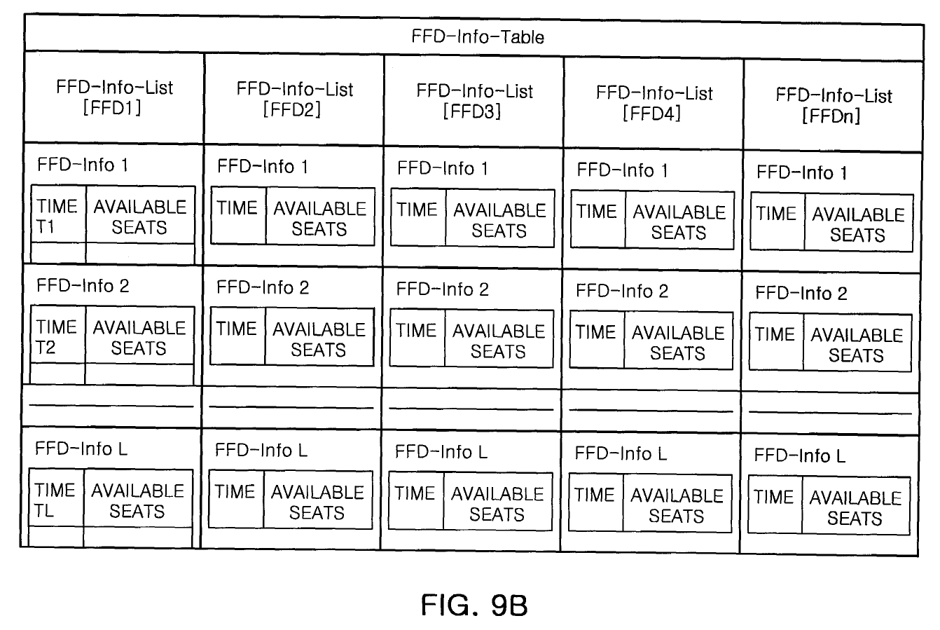

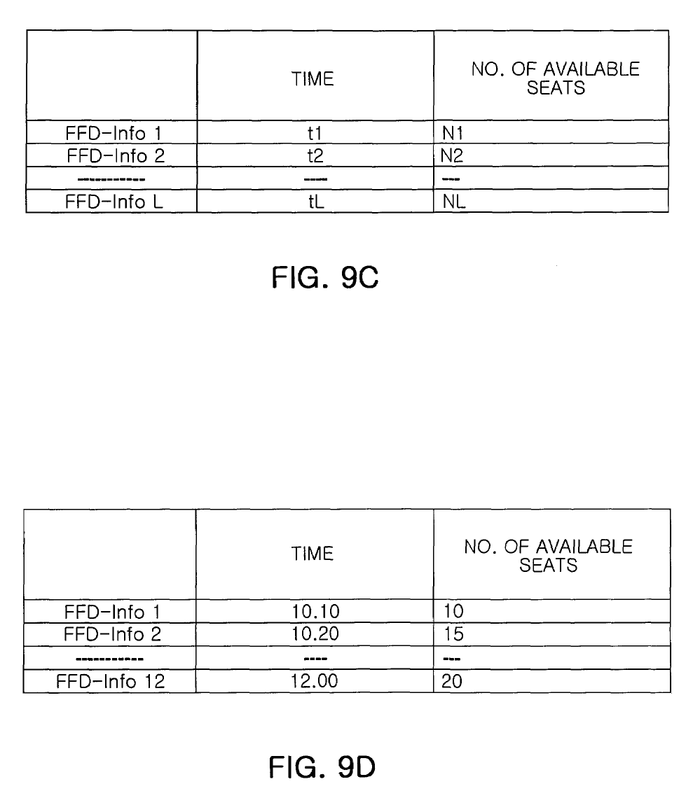

FIG. 9A is a diagram illustrating a predefined list that is transmitted from a FFD when the mobile communication device makes access to the FFD.

Referring to FIG. 9A along with FIGS. 1 to 3, a manager (of the system) in fact sets a list as shown in FIG. 9A to each of the FFDs 111 before the initial operation of network. In this case, the list is sequentially processed, based on the distance from a certain FFD 111 to the other FFDs 111. That is to say, the FFD 111 disposed in the nearest distance from the mobile communication device 120 occurs first on the list, but the FFD 111 disposed in the remotest distance from the mobile communication device 120 occurs last on the list.

Therefore, the information list is finally determined, based on the specific information and time-taken of the FFD 111. Here, the term “time-taken” means that a user walks at a normal speed of 5˜6 km/hr from a certain FFD 111 to another FFD 111.

Referring to FIG. 9A, it was shown that the FFD 2 is disposed in the nearest distance from the FFD 1, and the FFD [TFD] is disposed in the remotest distance from the FFD 1.

FIG. 9B is a diagram illustrating a FFD information table (FFD_Info_Table) containing information lists (FFD_Info_Lists) of respective FFDs on network.

Referring to FIG. 9B, each of the FFDs 111 maintains a constant state of the information table, and periodically updates the information table.

For example, the FFD 2 sends an individual information list, and then exchanges FFD information lists on the information table.

FIG. 9C is a diagram illustrating a FFD information table containing the time (Ti) and the number (Ni) of usable seats at a given time. Here, it is shown that T[i+1] has a higher value than T[i].

The initial determination of the FFD information list starts from a time, that is, T[0]=T_{current}+T_{offset}, where a time (T_{offset}) is slightly offset from a current time (T_{current}), wherein T_{offset} represents a kind of a buffer time, and T[i] precedes the current time. As a result, an equation T[i+1]=T[i]+Tᵢₙₜₑᵣᵥₐₗ is satisfied. Here, the Tᵢₙₜₑᵣᵥₐₗ is determined by amusement park sites. That is to say, a certain time is a time taken by the total number of users to finish their turns in a certain site.

Therefore, the Tᵢₙₜₑᵣᵥₐₗ must be calculated prior to the initiation of the system based on the substantial values. These parameters must be varied according to the sites, and be calculated for each FFD.

FFD_Info[i]=(T[i], N_{available})

Nₜₒₜₐₗ=N_{available}+N_{unavailable}

wherein, N_{available} represents the number of seats available at a time T[i] for a certain FFD, Nₜₒₜₐₗ represents the total number of seats available during a time period of Tᵢₙₜₑᵣᵥₐₗ. This indicates that Nₜₒₜₐₗ of users may be served for Tᵢₙₜₑᵣᵥₐₗ.

FIG. 9D shows one example of the FFD information table as shown in FIG. 9C.

Referring to FIG. 9D, the FFD information list has 12 final FFD information entries. When the current time is at 10 o'clock a.m., the time interval is set to 10 minutes. It may be seen that there are 10 available seats out of 20 seats at 10:10 a.m., and there are also 15 available seats out of 20 seats at 10:20 a.m.

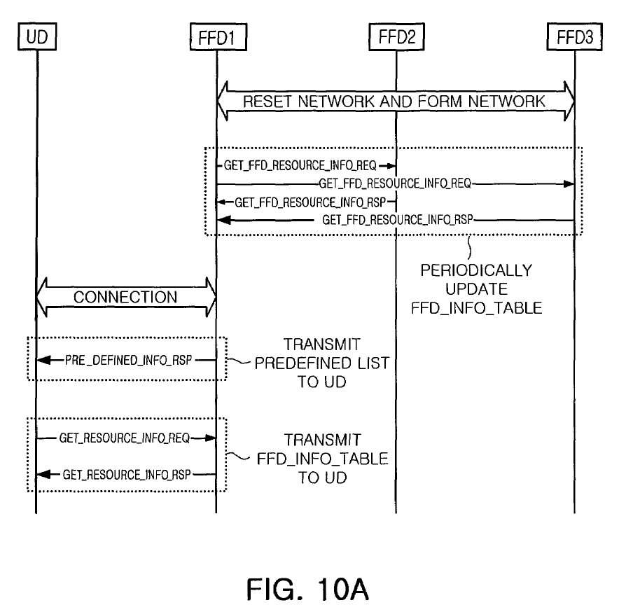

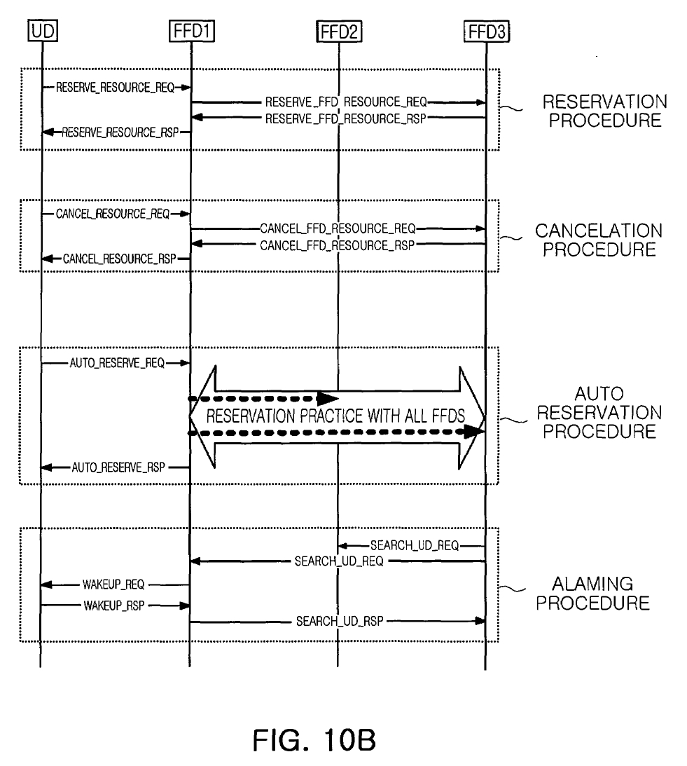

FIG. 10A and FIG. 10B are diagrams illustrating procedures of an amusement park reservation management protocol. In particular, FIG. 10A is a diagram illustrating a network and an automatic operation for resetting the network when the FFDS as shown in FIG. 2 are operated for the first time.

Referring to FIG. 10A and FIG. 10B along with FIG. 2, when the FFDs 111 are operated for the first time, they form and reset a network.

In this case, predefined information such as the identification numbers of FFDs 111 may be manually set to respective FFDs 111 by an administrator.

As described above, once the FFDs 111 form a network, each of the FFDs 111 starts to send a command, “GET-FFD_RESOURCE_INFO_REQ,” to all the other FFDs 111, and each of the other FFDs 111 responds with a command, “GET-FFD_RESOURCE_INFO_RSP.” As a result, each of FFDs 111 updates a kind of an information table, FFD-Info_Table. Therefore, in order to obtain information on the FFDs 111, these requests are periodically forwarded to continue to update the FFD-Info_Table.

Also, when one of the mobile communication devices 120 operates, the one mobile communication device 120 searches the FFDs 111 that may be connected with the mobile communication devices 120 for communication, and connects (cooperates) the FFDs 111. In this case, the connected FFD 111 sends a message, “PRE_DEFINED_INFO_RSP,” to the one mobile communication device 120. Here, the message carries predefined lists of the FFDs 111. The predefined lists are required by the mobile communication devices 120 in order to calculate the time for reminding a user by informing the user of a user's reminding time, that is, a remaining time in use of a certain amusement facility.

When a user wants to obtain information on another FFD 111, the user selects a necessary option displayed on a screen of the mobile communication device 120. In this case, the mobile communication device 120 sends a “GET_RESOURCE_INFO_REQ” command to the FFDs 111 connected with the mobile communication device 120. Also, the corresponding FFD 111 receives this request, and responds with a “GET_RESOURCE_INFO_RSP” command containing FFD_Info_Table as an effective load parameter. The mobile communication device 120 presents such information to users to select one of entries on the table for the purpose of the reservation.

When a user selects the final entry from a list that the user wants to make reservations, the mobile communication device 120 sends a “RESERVE_RESOURCE_REQ” command to the connected FFDs 111. In this case, the connected FFD 111, for example a first FFD (FFD 1), sends a “RESERVE_FFD_RESOURCE_REQ” command to a destined corresponding FFD 111, for example a third unified communication device (FFD 3) in order to make reservations within a give time. In this manner, the corresponding FFD 111 reserves a time slot for the mobile communication device 120, and stores this information in its own memory.

After the reservation of the time slot, the corresponding FFD 111 also responds with a command “RESERVE_FFD_RESOURCE_RSP” in response to the other FFDs 111 connected with the mobile communication device 120. In addition, the connected FFDs 111 send a command “RESERVE_RESOURCE_RSP” to the mobile communication device 120. In this manner, the mobile communication device 120 make entries, that is, a final reservation list on a user reservation table.

When a user wants to cancel the reservations, the mobile communication device 120 sends a “CANCEL_RESOURCE_REQ” command to the FFD 111 connected with the mobile communication device 120. Then, the FFD 111 connected with the mobile communication device 120 sends a “CANCEL_FFD_RESOURCE_REQ” command to a predefined FFD 111, for example a third FFD (FFD 3). As a result, the predefined FFD 111 deletes the reservations made for the mobile communication device 120, and sends a “CANCEL_RESERVE_REQ” command as a response signal to the FFDs 111 connected with the mobile communication device 120. In addition, the FFDs 111 connected with the mobile communication device 120 sends a “CANCEL_RESOURCE_RSP” command to the mobile communication device 120. As a result, the mobile communication device 120 removes the entries, namely, a final reservation list from the user reservation table.

Also, the “AUTO_RESERVE_REQ” command is sent to the FFD 111 recently connected with the mobile communication device 120 in order to make automatic reservations. In this case, the corresponding FFD 111 selects other FFDs 111, based on the recent sites and site availability of users. After the corresponding FFD 111 selects one of the FFDs 111, the FFD 111 connected with the mobile communication device 120 sends a reservation request command to a predefined FFD 111, and makes a user reservation table. Once the user reservation table is made, the user reservation table is sent to the mobile communication device 120 by the connected FFD 111 in response to the “AUTO_RESERVE_RSP” command.

Also, if the communication device 120 is lost it can be located from any of the FFDs 111, in this regard, for example, a third 3FFD (FFD 3) sends a “SEARCH_UD_REQ” command to all other FFDs 111, based on the association table of the FFDs 111, each FFD 111 compares identification of communication device 120 given in the “SEARCH_UD_REQ”, in order to detect the users' corresponding mobile communication devices 120, and a connection-confirming FFD 111, for example a first FFD (FFD 1), recently connected with the corresponding mobile communication device 120 responds with a “SEARCH_UD_RSP” command. In this case, the connected connection-confirming FFD 111 performs an alarm function by sending a “WAKEUPUP_REQ” command to the mobile communication device 120 connected with the connection-confirming FFD 111, depending on the command of the FFD 111 containing the final reservation list. After the performing of the alarm function, the corresponding mobile communication device 120 responds with a “WAKEUP_RSP” command to the FFD 111 currently connected with the corresponding mobile communication device 120. On receiving “WAKEUP_RSP” a command corresponding FFD 111 sends “SEARCH_UD_RSP” command to the originator of the request command.

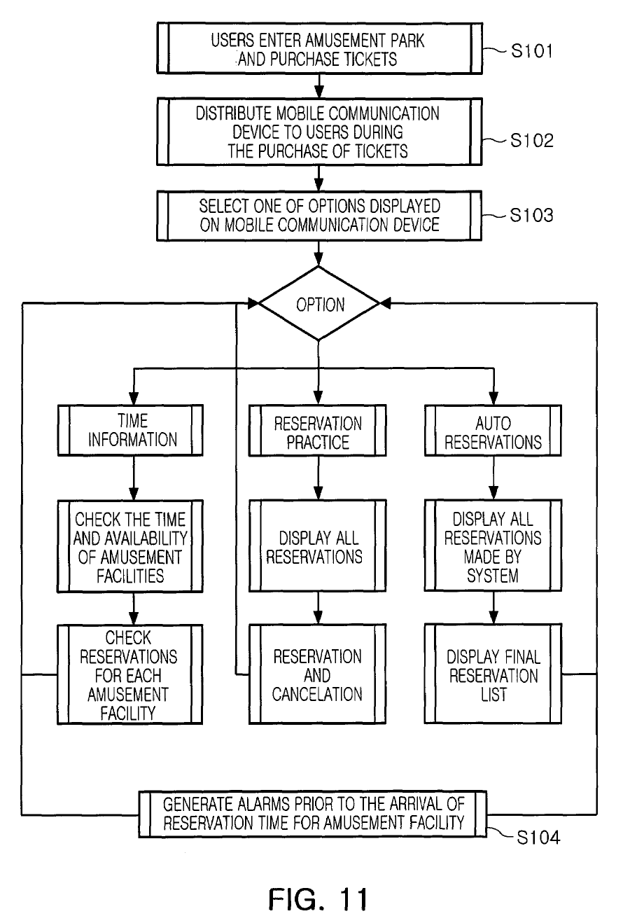

FIG. 11 is a flowchart illustrating procedures of making visitor's reservations.

Referring to FIG. 11, people who visit or enter the amusement park purchase tickets, that is, admission tickets from way ins of the amusement park or counters provided separately in the way ins (S101).

In this case, a mobile communication device is also provided to perform reservations for amusement facilities in the amusement park as the same time as the purchase of tickets (S102).

Then, each of the users of the amusement facilities selects one of options displayed on a screen of the mobile communication device (S103).

In this case, the options are divided into a view-info mode, a reservation practice mode, and an auto reservation mode.

When the view-info mode is selected, a user can check the site time and availability of each amusement facility, and receive information on reservations made by the system by selecting the amusement facilities one by one.

Also, when the reservation practice mode is selected, the information on all the reservations is displayed on a display block of the mobile communication device. In this case, the users further make reservations or cancel the reservations, depending on the information on the reservations.

When auto reservation mode is selected, all the reservations are made by the system, and their reservation lists are displayed on the display block of the mobile communication device.

Also, when the reservations are made in this manner, the users of the amusement facilities receive alarms such as alarm messages prior to the arrival of users' reservation time (S104).

Finally, based on the above-mentioned context, the present invention is characterized in that a FFD 111 search mobile communication devices carried by each user of the amusement park, which are disposed in the nearest distance from FFD 111, to find one of the mobile communication devices and connect with the mobile communication device in order to communicate with each other, and the connected FFD transmits the reservations made by the mobile communication device to the other corresponding FFDs, and controls an entry system of each amusement facility according to the reservation state.

As described above, the amusement park management system according to one exemplary embodiment of the present invention may be useful to enhance the operation efficiency of amusement parks by reducing the waiting time of users who want to use the amusement facilities.

While the present invention has been shown and described in connection with the exemplary embodiments, it will be apparent to those skilled in the art that modifications and variations can be made without departing from the scope of the invention as defined by the appended claims.

Therefore, it should be understood that the scope of the invention is not limited by the above-mentioned exemplary embodiments and the accompanying drawings, but limited by the appended claims of the present invention.

What is claimed is:

1. An amusement park management system, comprising:
at least one mobile communication device containing identification information and transmitting reservation information including the number of reserved seats in a corresponding amusement facility out of a plurality of amusement facilities in an amusement park;
a plurality of wireless network devices provided in the way ins/outs of the amusement park and the amusement facilities to form a mutual wireless local area network, and making an access to the mobile communication device to store the identification information of the mobile communication device and the reservation information; and
a plurality of entry systems provided in gates of the amusement facilities to communicate with each of the plurality of wireless network devices,
wherein each of the plurality of entry systems compares the identification information of the mobile communication device stored in the wireless network devices of the corresponding amusement facility with the identification information of the mobile communication device, compares the number of users using the corresponding amusement facility with the number of reserved seats in the corresponding amusement facility and controls the users' entrance and exit of sites according to the comparison results.

2. The amusement park management system of claim 1, wherein the wireless network device is a full functional device (FFD) provided with a communication module used to form a ZigBee or wireless LAN network.

3. The amusement park management system of claim 2, wherein the communication module of the FFD used to form the ZigBee network comprises:
an application/profiles layer corresponding to a user setting region;
a frame layer and a network/security layer corresponding to regions as stipulated in the ZigBee alliance standard; and
an MAC layer and a PHY layer corresponding to regions as stipulated in the IEEE 802.15.4 standard.

4. The amusement park management system of claim 3, wherein the communication module of the FFD comprises:
an antenna transmitting and receiving a frequency signal;
a RF receiver and transmitter block making access to the antenna to transmit and receive a frequency signal of a corresponding band and process the frequency signal of the corresponding band into a digital signal of a base band region;
a phase-locked loop making access to the RF receiver and transmitter block to provide a reference frequency signal to the RF receiver and transmitter block so that the RF receiver and transmitter block generates an intermediate frequency signal;
a MAC processor block making access to the RF receiver and transmitter block to process the connection of initial hardware networks, analyzing a frame structure of a data signal transmitted from the RF receiver and transmitter block to approve frames, sensing errors to determine whether a data signal is re-transmitted, and processing packet routing;
a controller block making access to the MAC processor block to construct a network topology by performing a software function, a function of the network/security layer and a function of the frame layer in addition to the hardware function and to transmit application data by performing the function of the application/profiles layer; and
an electrically erasable programmable read-only memory (EEPROM) recording information on the network topology configuration, temporally storing data arithmetically operated at the MAC processor block and the controller block, and storing information on the analysis of the protocol.

5. The amusement park management system of claim 1, wherein the mobile communication device comprises a mobile phone or personal digital assistant (PDA) having a display block to display the data information on a screen thereof.

6. The amusement park management system of claim 1, wherein the entry system comprises:
an ID detector detecting the identification information of the mobile communication device;
a user detector detecting the number of users of the amusement facilities; and
a controller comparing data information provided from the wireless network device with detection information of the ID detector and the user detector and controlling the entrances of the amusement facilities according to the comparison results.
